(19) United States
(12) Patent Application Publication
(10) Pub. No.: US 2003/0143341 A1
(43) Pub. Date: Jul. 31, 2003

(54) Dieletric thin films from fluorinated benzocyclobutane precursors

(75) Inventor: Chung J. Lee, Fremont, CA (US)

Correspondence Address: JACKSON WALKER LLP, 2435 NORTH CENTRAL EXPRESSWAY, SUITE 600, RICHARDSON, TX, 75080, US

(73) Assignee: DIELECTRIC SYSTEMS, INC., Fremont, CA (US)

(21) Appl. No.: 10/029,373

(22) Filed: Dec. 20, 2001

(51) Int. Cl. C09K 19/00

(52) U.S. Cl. 428/1.1

(57) ABSTRACT

New precursors and processes are provided to generate fluorinated low dielectric constant, ε films that have higher dimensional stability and more rigid than fluorinated Poly (Para-Xylylenes). The low ε films are prepared primarily from polymerization of precursors consisting of both benzocyclobutane and unsaturated carbon-carbon groups such as vinyl (C═C) and ethylenic groups. The low ε polymers consists primarily of SP²C—F, hyperconjugated Sp³C_{α}—F type or/and Sp³Si_{α}—F fluorine. The low ε (<2.4) films are useful for fabrications of future<0.18 μm ICs. Using low ε films prepared according to this invention, the integrity of dielectric, Cu and its barrier metals such as Ta can be kept intact; therefore reliability of these ICs can be assured.

### BACKGROUND

One of the primary objective of this invention is to reveal new precursors and chemistries for making spin-on films that are useful for the fabrication of integrated circuits (“IC”). More specifically, this invention describes thin films that are produced from fluorinated benzocyclobutane (“BCB”) precursors. The resultant thin films have increased dimensional stability, a low-dielectric constant (“ε”), and are stable at high temperatures. The thin films described herein can be incorporated into the manufacturing processes that use the Copper Dual Damascene process. Additionally, material chemistries that are useful for making porous Poly (BCB) films with various porosity and dielectric constants (<2.0 to 1.8) are disclosed. In addition to the disclosure of the precursors for the dielectric thin films, a spin-on process for producing dielectric thin films in the manufacturing process is also discussed.

As integrated circuits (“ICs”) have become progressively more microminiaturized to provide higher computing speeds, current dielectric materials used in the manufacturing of the ICs have proven to be inadequate in several ways. These materials, for instance, have high dielectric constants, difficulty to use in the manufacturing process, have inadequate thermal instability and generate toxic by-products. ICs are made by depositing layers of elements and/or compounds on a semiconductor wafer using a variety of techniques that are well known in the art of fabricating such devices. Specialized material are used to isolate layers on the IC and reduce the charge (i.e. capacitance) that can be stored in between conducting elements of the IC. To reduce the potential capacitance in certain layers, it is preferable that the materials have a low dielectric constant (“ε”). Low dielectric constant materials can be deposited by a variety of methods, including spin-on and chemical vapor deposition (CVD). The composition and characteristics of the dielectric materials are determined from its precursors as well as the processes and reactions such precursors undergo while being integrated into the IC. As used herein, spin-on refers to the IC manufacturing process whereby the substrate is rotated about an axis perpendicular to its surface while, or immediately after, a coating material is applied to the surface. As ICs become smaller and more functional, a dielectric material with ε that is 2.7 or lower will be required.

Other properties such as thermal stability, compositional integrity and process compatibility are important factors that must be considered when integrating a dielectric material into an IC. For example, a dielectric material should retain its integrity during many processes involved in IC fabrication. These processes include reactive ion etching (“RIE”) or plasma patterning, wet chemical cleaning of photoresist, physical vapor depositions (“PVD”) of barrier materials and cap layers, electroplating and annealing of copper (“Cu”) and chemical-mechanical polishing (“CMP”) of copper. In addition, the dielectric should have sufficient dimensional stability. Interfacial stresses resulting from a coefficient of thermal expansion (“CTE”) mismatch between the dielectric and barrier material should not induce structural failure of the barrier material during and after annealing of copper. In addition, the interfacial adhesion of dielectric and the other barrier material should be sufficient to overcome interfacial and shear stresses and warrant good adhesion after annealing and CMP of copper. Corrosive organic elements used for IC processing can cause interfacial corrosion of the barrier material, and it is essential that the dielectric material does not allow the organic elements to diffuse into the barrier material layer. In addition, to maintain its electrical integrity after fabrication of the ICs, the dielectric should be free from contamination by the barrier material. Furthermore, the interfaces of dielectric and the barrier material should be free from moisture and no ionic migration occurs when the ICs are operating under electrical bias.

Dielectric materials that have been traditionally used in ICs were either solid or porous thin films. There are advantages and disadvantages to each. For example, the advantages of solid dielectric materials include: higher dimensional and structural integrity and better mechanical strength than porous dielectric materials, but the disadvantage is higher dielectric constant. In contrast, the advantage of porous dielectric materials is lower dielectric constant due to the presence of air inside tiny pores of these materials. Current solid materials are unable to achieve stability, integrity and strength with a dielectric constant below 2.7.

The “solid” polymer films or “pin-hole free” films contain voids that can generally range between 3 to 5 volume % of the films. However, the average void sizes in a cross-section of a well prepared “pin-hole free” or “solid” films are only few Angstroms. It is critical that the pore sizes of the thin films be relatively small in order to be useful for fabrication of current or future generation of ICs. For example, the pore sizes should be less than the mean free path (i.e. 50 to 100 Angstroms) of the barrier material, which is typically Tantalum (“Ta”).

The removal of solvents or sacrificing materials can result in additional porosity and low dielectric constant in “pin-hole-free” polymer films. However, when the sacrificing materials have different compatibilities with the polymer matrix, the result can lead to polymer aggregation and pore sizes larger than 100 Angstroms. The resulting thin film dielectric has poor mechanical properties due to localized degradation caused by large pores or their aggregates. The presence of pores in these dielectric materials normally results in holes on newly formed surfaces, thus making subsequent depositions of a continuous, thin (<50-100 Å) barrier layers and copper seed layers very difficult if not impossible. Additional problems with traditional porous thin films are they often exhibit reliability problems due to the inclusion of barrier metal inside the dielectric layer, as occurs after PVD of Ta. Porous dielectric materials are also difficult to integrate into IC fabrications that involve a CMP process. To further complicate the process, large surface areas in porous films lead to high water adsorption that can limit the electrical reliability of the IC.

Precursors such as Bicyclobutene (“BCB”) can be used to make thin films in a copper dual damascene structure without the need for a barrier layer such as Ta, however, the dielectric constant of BCB is greater than 2.7. Introduction of air bubbles into the BCB during the process can increases porosity and a consequential decrease of the dielectric constant. At 20% porosity, BCB has a dielectric constant of about 2.3. Unfortunately, the porous BCB and other dielectric materials that can achieve a ε≦2.4 are too soft for CMP and not suitable for fabrication of current and future ICs.

Plasma polymerization of fluorinated precursor molecules has also been described. For example, Kudo et al., Proc. 3d Int. DUMIC Conference, 85-92 (1997) disclosed polymers made from C₄F₈ and C₂H₂ with a dielectric constant of 2.4. The polymers had a glass transition temperature (“Tg”) of 450° C. However, despite its low leakage current due to presence of sp³C—F bonds, a low thermal stability occurred due to presence of sp³ C—F and sp³C-sp³-C bonds in the films. Thus, these fluorinated polymers are unable to withstand the prolonged high temperatures necessary for IC manufacture. In addition, LaBelle et al, Proc, 3d Int. DUMIC Conference, 98-105 (1997) also described the use of CF₃—CF(O)—CF₂ precursors in a pulsed plasma CVD process, which resulted in some polymer films with a dielectric constant of 1.95. However, in spite of the low dielectric constant, these polymer films also had a low thermal stability due to presence of sp³C-sp³C and sp³C—F bonds in these films.

Other fluorinated compounds described by Wary et al, (Semiconductor International, June 1996, 211-216) used the dimer precursor, (α, α, α¹, α¹), tetrafluoro-di-p-xylylene (i.e. {—CF₂—C₆H₄—CF₂—}₂) and a thermal CVD process to manufacture Parylene AF-4™, which has the structural formula: {—CF₂—C₆H₄—CF₂—}ₙ. Films made from Parylene AF4™, have a dielectric constant of 2.28 and have increased thermal stability compared to the above-mentioned dielectric materials. Films made of Parylene AF-4™ lost only 0.8% of its weight over a 3 hour period at 450° C. under a nitrogen atmosphere. However, there are disadvantages to the known methods the manufacture of the fluorinated poly (Para-Xylylenes), or Parylene AF₄™. First, the manufacture of their precursors is inefficient because the chemical reactions have low yields, and the process is expensive and produces toxic byproducts. Further, it is difficult to eliminate redimerization of the reactive intermediates. When deposited along with polymers, these dimers decrease the thermal stability and mechanical strength of the film.

In our co-pending applications, we have disclosed some pin-hole-free polymer dielectric that can be prepared from transport polymerization process. These dielectric materials consist of sp²C—F and hyperconjugated sp³C—F in their polymer chains, thus they have ε≦2.4, and they are thermally stable for fabrication of future ICs. Herein, we describe precursors and processes for making thin films from precursors that results in polymers with low dielectric constant, improved compositional strength and high temperature stability that should provide low cost alternatives for fabrication of miniaturized ICs.

### SUMMARY

One of the primary objectives of this invention is to reveal new precursors and chemistries for making spin-on films that are useful for the fabrication of integrated circuits. More specifically, this invention describes thin films that are produced from fluorinated benzocyclobutane (“BCB”) precursors. The resultant thin films have increased dimensional stability, a low-dielectric constant (“ε”), and are stable at high temperatures. The thin films described herein can be incorporated into the manufacturing processes that use the Copper Dual Damascene process. Additionally, material chemistries those are useful for making porous Poly (BCB) films with various porosity and dielectric constants (<2.0 to 1.8) are disclosed. In addition to the disclosure of the precursors for the dielectric thin films, a spin-on method for producing dielectric thin films in the manufacturing process is also discussed. Other objects, aspects and advantages of the invention can be ascertained from the review of the detailed disclosure, of the examples, the figures and the claims.

### DETAILED DESCRIPTION OF PREFERRED EMBODIMENTS

The term “unsaturated carbon-carbon containing group” as used herein refers any unsaturated carbon-carbon bonds (e.g. olefinic, or ethylenic group).

The term “fluorinated group” as used herein refers to a fluorine (e.g. —F), a fluorinated alkyl (e.g. —CF₃) or a fluorinated phenyl group (e.g. —C₆F₅). Fluorinated groups are used in equations (I), (Ia), (II) and (IIa), and are denoted as R, R′, R′″, R″″, X, X′, X′″, or X″″.

The term “fluorinated-aromatic-moiety” as used herein refers to but are not limited to: the phenyl moiety, —C₆H₄₋ₙFₙ-(n=0 to 4) such as —C₆H₄— and —C₆F₄—; the naphthenyl moiety, —C₁₀H₆₋ₙFₙ-(n=0 to 6) such as —C₁₀H₆— and —C₁₀F₆—; the diphenyl moiety, —C₁₂H₈₋ₙFₙ-(n=0 to 8) such as —C₆H₂F₂—C₆H₂F₂—; and —C₆F₄—C₆H₄—; the anthracenyl moiety, —C₁₂H₈₋ₙF_{n;}—; the phenanthrenyl moiety, —C₁₄H₈₋ₙFₙ—; the pyrenyl moiety, —C₁₆H₈₋ₙFₙ— and more complex combinations of the phenyl and naphthenyl moieties, —C₁₆H₁₀₋ₙFₙ—. It is also important to note that isomers of various fluorine substitutions and reaction groups on the aromatic moieties are also included in this invention.

The term “benzocyclobutane group” as used herein refers to but, are not limited to a structure as shown in FIG. III, wherein the W's is a hydrogen, a fluorine, a fluorinated phenyl.

The term “linker group” as used herein refers to, but are not limited to —O—CH₂—O—, —O—CF₂—O—, —Si(R′)₂—O—Si(R)₂—, —O—, —CO—. —O—FSiF—O—, and —O—Ar—O— groups, consisting of a hyperconjugated Sp³C_{α}—F or/and —Sp³Si_{α}—F fluorine such as —C_{α}F₂— and preferably a linker group is —Si_{α}F₂ group. The Si_{α} and C_{α} is an Alpha Silicon or Carbon that is directly linked to an unsaturated C═C bonds, preferably to an aromatic moiety. Herein, the Si_{α} and C_{α} is thus a hyperconjugated carbon or silicon. Due to hyperconjugation (see p275, T. A. Geissman, “Principles of Organic Chemistry”, 3rd edition, W. H. Freeman & Company), these —C_{α}—F and —Si_{α}—F bonds have some double-double bond character, thus they are stable for fabrications of future ICs.

This invention discloses thin fluorinated films with low dielectric constants (“ε”) that are useful in the manufacture of integrated circuits and other electronic devices. Manufacture of smaller and faster integrated circuits requires inter-metal dielectric (IMD) and inter-level dielectric (ILD) materials that minimize the “cross-talk” of electrical signals between adjacent conductive lines. Low dielectric constant materials are useful to minimize “cross-talk” within and between layers of integrated circuits in addition to serve many other purposes.

The polymers prepared from the precursors of the present invention contain a high degree of substitution of hydrogen atoms by fluorine atoms. In these polymers, the fluorine in the aromatic ring provides the low dielectric constant below about 2.6 and high molecular rigidity. This rigidity is reflected by high glass transition temperature (Tg), high elastic modulus (E) and high shear modulus (G). Their elastic modulus is above about 2.5, and mostly is above 3.5 GPa.

Films made from Parylene AF44™ have a dielectric constant of 2.28 and have increased thermal stability compared many different dielectric materials. However, there are disadvantages to the known methods the manufacture of Parylene AF44™. Despite these disadvantages, it is important to understand the advantages of such polymer in order to produce the next generations of thin films. Although not wanting to be bound by theory, the thermal stability of the Parylene AF44™ is due to the high bonding energies of the sp²C=sp²C, sp²C—H and sp²C-sp³C bonds of 145, 111 and 102 kcal/mol respectively. In addition, the sp³C—F bonds may also be involved in hyperconjugation with sp²C=sp²C double bonds of the adjacent phenylene groups in Parylene AFF4™. This hyperconjugation renders higher bond energy for the sp³C—F bonds than are found in non-hyperconjugated sp³C—F bonds.

Thus, polymers consist of sp²C=sp²C, sp²C—F and hyperconjugated sp³C—F bonds confer advantages, whereas other types of bonds (such as sp³C—F and sp³C—H bonds) do not confer these advantages. The sp²C=sp²C and other sp²C bonds increase the mechanical strength and increase Td (Decomposition Temperature) of the polymers. The fluorine atoms on the aromatic moieties of the polymers of this invention decrease the dielectric constant and the sp²C—F and hyperconjugated sp³C—F bonds confer greater thermal stability to these polymers. In contrast, polymers that do not contain these types of bonds have lower thermal stability and higher dielectric constant.

One embodiment of the present invention pertains to fluorinated precursors and processes for making thin polymer films that have low-dielectric constant and have improved dimensional stability, and are stable at high temperatures. In particular, this invention relates to novel fluorinated precursors and the methods to process these fluorinated precursors. These polymers have a dielectric constant F equal to or less than 2.7, thus are useful in the fabrication of ICs. The present invention preferably uses the spin on method to dispense the fluorinated precursors onto the wafer.

Broadly, dielectric thin films with low ε can be prepared from a precursor with elements comprising: an unsaturated carbon-carbon group; a fluorinated group; a fluorinated-aromatic-moiety; and a benzocyclobutane group with the precursor having the following general structure:

Y-Z-Si(R′R″)—Ar—{Si(R″″R′″)-Z′-Y′}_{n°-1} (I)

More specifically, Y and Y′ are the benzocyclobutane group; Z and Z′ are the unsaturated carbon-carbon containing group; Si is a silicon; R′, R″, R′″ and R″″ are the fluorinated groups; Ar is a fluorinated-aromatic-group-moiety; and n° is an integer of at least 1 but no more than a total number of sp²C—H substitution on the fluorinated-aromatic-moiety. A further explanation of the different groups are as follows: the benzoxyclobutane group (Y or Y′) has a general structure illustrated in FIG. III.

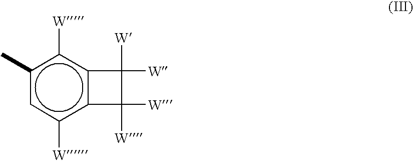

Wherein, the W's is -hydrogen, -fluorine or a fluorinated phenyl. The unsaturated carbon-carbon containing groups (Z and Z′) are olefinic (—C═C—) groups, or ethylenic (—C≡C—) groups. The fluorinated groups (R′, R″, R′″ and R″″) are selected from a fluorinated alkyl (—C—F₃), or a fluorinated phenyl (—C₆F₅), preferably a —F. The fluorinated-aromatic-moieties (Ar) include, but are not limited to: the phenyl moiety, —C₆H₄₋ₙFₙ-(n=0 to 4) such as —C₆H₄— and —C₆F₄—; the naphthenyl moiety, —C₁₀H₆₋ₙFₙ-(n=0 to 6) such as —C₁₀H₆— and —C₁₀F₆—; the diphenyl moiety, —C₁₂H₈₋ₙFₙ-(n=0 to 8) such as —C₆H₂F₂—C₆H₂F₂— and —C₆F₄—C₆H₄—; the anthracenyl moiety, —C₁₂H₈₋ₙF_{n;}—; the phenanthrenyl moiety, —C₁₄H₈₋ₙFₙ—; the pyrenyl moiety, —C₁₆H₈₋ₙFₙ— and more complex combinations of the phenyl and naphthenyl moieties, —C₁₆H₈₋ₙFₙ—. It is also important to note that isomers of various fluorine substitutions and reaction groups on the aromatic moieties are also included in this invention.

Thin films made from the above precursor (I) will generate liner polymers (when n°=1 or cross-linked polymers (when n°>1) via the chemical reaction between the benzocyclobutane group and the unsaturated carbon-carbon group as follows:

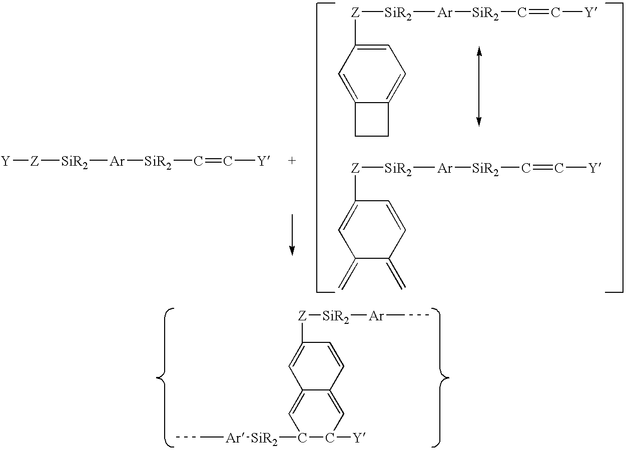

Additionally, dielectric thin films with low ε can be prepared from a precursor with elements that are slightly modified from the elements discussed above. For example precursors comprising: an unsaturated carbon-carbon group; a fluorinated group; a fluorinated-aromatic-group-moiety; and a benzocyclobutane group with the precursor having the following general structure (II):

Y-Z-C(X′X″)—Ar—{C(X″″X′″)-Z′-Y′}_{n°-1} (II)

are also suitable for the production of thin films. Wherein the X's in the above is a —H or —F. n° is an integer of at least 1 but no more than a total number of sp²C—H substitution on the fluorinated-aromatic-moiety. In addition, Ar can also be an aromatic moiety-containing compounds of the following general structures: —P-L-P′— Herein, P and P′ is selected from Ar in the above (I). The L represents a linkage unit such as —O—CH₂—O—, —O—CF₂—O—, —Si(R′)₂—O—Si(R)₂—, —O—, —CO—. —O—FSiF—O—, and —O—Ar—O— groups, preferably a linkage unit consisting of a hyperconjugated Sp³C_{α}—F or/and -Sp³Si_{α}—F fluorine such as —C_{α}F₂— and Si_{α}F₂ group. Here above, R is selected from —F, an aromatic radical, an alkyl radical, —CH₃, or preferably a —CF₃.

Furthermore, Ar and Ar′ can also be an oligomers or a low molecular weight polymers. An oligomer is a molecule consisting of many (2 to 10) repeating units in its backbone structure whereas a polymer is macromolecules consisting of more than 10 to 20 repeating units in its backbone structure.

In order to achieve the low dielectric constant of 2.2 or lower, that is useful for future ICs' fabrication, the above precursors should consist of sufficient amount of fluorine substitution to hydrogen in their sp²C—H and sp³C—H bonds. Additionally, to achieve the desirable thermal stability and higher rigidity, the above precursors should consist of substantial amount of fluorine substitution to hydrogen in their sp³C—H bonds. In general, all Hydrogen in sp³C—H should be replaced with fluorine in order to maximize the thermal stability for future IC fabrication. However, exception can be found for precursors that consist of sp³C_{α}—H bond. Herein, C_{α} is denoted to an alpha carbon connecting to an aromatic group. Due to hyper-conjugation principle, it is known that this Sp³C_{α}—H bond is substantially more thermally stable than that of a Sp³C—H bond.

To achieve the required ε=2.2, he total amount of fluorine substitution to hydrogen needed for this invention can be estimated as follows. It is known that without any fluorine substitution to hydrogen for the above precursors (I) & (II), the resulting dielectric would have ε of about 2.65 to 2.75.

It is also known form our studies that when each sp²C—H bond is replaced with a sp²C—F bond, ε of the resulting dielectric will be lowered at 0.05 to 0.07 per substitution, with a limiting lowest 8 of about 1.9. Therefore, If the precursor (I) is used, the ratio of (sp²C—F+sp³C—F)/((sp²C—F+sp³C—F+sp²C—H+sp³C—H) should be at least 0.4. If the precursor (II) is used, the ratio of (sp²C—F+sp³C—F)/((sp²C—F+sp³C—F+sp²C—H+sp³C—H) should be at least 0.8. The above principles are particularly useful when oligomeric (I) or (II) precursors are used.

Applying the above principles, following exemplary precursors are useful for producing thin films with a low dielectric constant in the present invention.

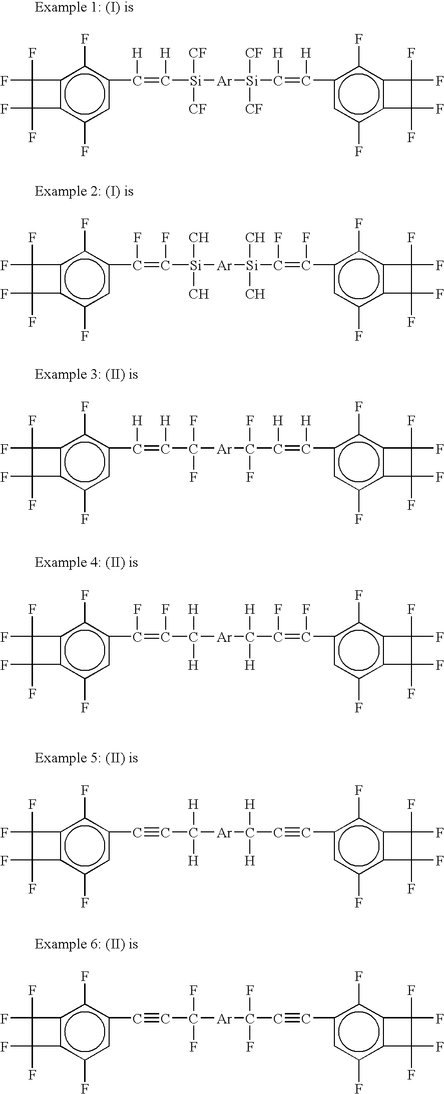

Where above, Ar can be —C₆F₂H₂ or —C₆F₄—.

(III-B). Processing Procedures for Pinhole Free Thin Films:

Precursor molecules (e.g. compound I or II, or their mixture) are first dissolved or suspended in an appropriate solvent. The solution or suspension is then dispensed onto the surface of interest by the spin-on technique, which results in a thin wet film. The thin wet film is then heated at 3 to 5° C. per minute to a predefined maximum temperature (“Tₘₐₓ”). Thus, the wet film is heated from 5 to 50° C. below the boiling point until a dried film is formed. The resultant dried film is then heated at 10° C. per minute to a Tₘₐₓ that ranges from 10 to 20° C. below the glass transition temperature (“Tg”) of the thin film. A thin film according to this invention has a dielectric constant of less than 2.6, preferably less than 2.4. Thus, thin film can be prepared from the polymerization of precursors with the general structures (I) and (II). These thin films are useful for the manufacture of ICs, active matrix LCDs or a fiber optic device. In addition, this invention will provide thin films that are compatible with the Dual Damascene process used in manufacturing of future ICs.

The heating and curing processes described in the above should preferably conducted under non-oxidative, inert conditions to prevent oxidation of pre-polymers. Ideally, the processes should be conducted under nitrogen or vacuum condition on hot plate and inside an oven. The final heating or curing process should be at least 5 to 10 minutes if conducted on a hot plate, and should be at least 20 to 30 minutes if conducted inside an oven. The final cure temperature should be at least reaching to 5 to 10 ° C. below its maximum achievable Tg, Tg(max). From a practical point of view, Tg(max)is defined here for the Tg that can be obtained by heating the dielectric inside a sample cell in DSC (Differential Scanning Calorimeter) to 450 ° C. at 10° C. per minute heating rate under nitrogen atmosphere. The Tg(max) can be obtained by re-scanning the dielectric material inside the sample cell under the same conditions.

In order to achieve a dielectric constant of 2.7 or lower, the above referenced precursors should consist of a sufficient amount of F substitution to H in their sp²C—H and sp³C—H bonds. Further, in order to achieve thermal stability and higher rigidity, the above referenced precursors should consist of a substantial amount of F substitution to H in their sp³C—H bonds. In general, all sp³C—H should be replaced with F in order to achieve the thermal stability required in IC fabrication. The immediately foregoing does not apply to precursors that include a sp³C_{α}—H bond, wherein C_{α} is an alpha carbon connecting to an aromatic group. According to hyper-conjugation principle, the sp³C_{α}—H bond is substantially more thermally stable than that of a sp³C—H bond. However, to achieve a dielectric constant ε<2.4, the total amount of F substitution to H can be estimated as follows.

It is known that without any F substitution to H for the above precursors (I) and (II), the resulting dielectric will have a constant ε of about 2.65 to 2.75. However, when each C—H bond is replaced with a C—F bond, the constant ε of the resulting dielectric polymer will be lowered at 0.05 to 0.07 per substitution with a limiting lowest ε of about 1.9. Therefore, the ratio of (sp²C—F+sp³C—F)/(sp²C—F+sp³C—F+sp²C—H+sp³C—H) of resulting thin films should be at least 0.4, preferably 0.7.

To make thin films from the above referenced precursors (I) and (II), in general, such precursors are spin coated onto the wafer. The wet film is then conditioned under slow heating rates (3 to 5° C./minute) to remove most (80 to 90%) of the solvent(s). The resulting dry films are then exposed to polymerization conditions that normally have various time-temperature-heating rate schedules.

Under proper processing conditions, solid, “pinhole-free” thin films useful for fabrication of ICs can be obtained. To obtain “pinhole-free” thin films, solvent-drying temperatures generally need to be at least 20 to 50° C. below the boiling temperature of the solvent. In addition, it is desirable to heat the wet film under an inert gas such as nitrogen. Polymerization can then be carried out by heating the resulting wet films slowly from (Tb-20 to 50) to (Tg-T)° C. Wherein, Tg is the attainable glass transition temperature for a given polymer and T ranges from 20 to 50° C. Preferably, (Tg-T) preferably should not exceed 450° C. When (Tg-T) approaches 400 to 450° C., the heating time should be less than 30 to 60 minutes under such temperatures. During polymerization, the heating rate normally ranges from 20 to 30° C./minute depending on the thickness of the films. For making thin films (<1-2 μm), heating rate can be as high as 40 to 50° C./minute.

The invention includes novel precursors containing a fluorinated aromatic moiety. The precursors are suitable for making thin films with low dielectric constants and high thermal stability. Additionally, the invention includes methods for applying thin films of this invention for various electronic devices. Therefore, integrated circuits, liquid crystal displays or fiber optic devices that consist of these thin films should have improved electrical and mechanical performances.

It should be appreciated by those of ordinary skill in the art that other embodiments may incorporate the concepts, methods, precursors, polymers, films, and devices of the above description and examples. The description and examples contained herein are not intended to limit the scope of the invention, but are included for illustration purposes only. It is to be understood that other embodiments of the invention can be developed and fall within the spirit and scope of the invention and claims.

What is claimed:

1. A dielectric thin film prepared from a precursor of a general structure (I):
Y-Z-Si(R′R″)—Ar—{Si(R″″R′″)-Z′-Y′}_{n°-1} (I)
wherein, Y and Y′ are the same or different benzocyclobutane moieties;
Z and Z′ are the same or different, and individually a olefinic (“C═C”) group, or an ethylenic (“C≡C”) unsaturated carbon-carbon containing group;
R′, R″, R′″ and R″″ are the same or different, and individually a —F, a fluorinated alkyl group, or a fluorinated phenyl group;
Ar is an aromatic group moiety having a general structure: —C₆H₄₋ₙFₙ-(n=0 to 4); C₆H₄₋ₙFₙ—CF₂C₆H₄₋ₙFₙ-(n=0 to 8); —C₁₀H₆₋ₙFₙ-(n=0 to 6); —C₁₂H₈₋ₙFₙ-(n=0 to 8)-C₁₂H₈₋ₙFₙ;—C₁₄H₈₋ₙFₙ;—C₁₆H₈₋ₙFₙ; —C₁₆H₁₀₋ₙFₙ—; or —O—; and
n° is an integer of at least 1 but no more than a total number of sp²C—H substitution on the fluorinated-aromatic-group-moiety.

2. The precursor of claim 1, wherein the benzoxyclobutane moiety has a general structure comprising (III): 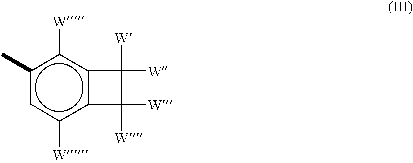
wherein, W′, W″, W′″, W″″, W′″″, and W″″″ are the same or individually a hydrogen, a fluorine or a fluorinated phenyl.

3. The thin film of claim 1, wherein a ratio of (sp²C—F+sp³C—F)/((sp²C—F+sp³C—F+sp²C—H+sp³C—H) substitutions should be at least 0.4, preferably 0.7

4. The thin film of claim 1, wherein the dielectric thin film has a dielectric constant (“ε”) value equal to or less than 2.6.

5. The dielectric thin film of claim 1, wherein one or more layers of the thin film is deposited on an integrated circuit or electronic device.

6. The dielectric thin film of claim 5, wherein the electronic device comprises: an active matrix liquid crystal display, or a fiber optic device.

7. The dielectric thin film of claim 5, wherein the integrated circuit is manufactured via a dual damascene process comprising the dielectric thin film.

8. A dielectric thin film prepared from a precursor of a general structure (II):
Y-Z-C(X′X″)—Ar—{C(X″″X′″)-Z′-Y′}_{n°-1} (II)
wherein, Y and Y′ are the same or different benzocyclobutane moieties;
Z and Z′ are the same or different, and individually a vinyl, olefinic (“C═C”) group, or an ethylenic (“C≡C”) unsaturated carbon-carbon containing group;
X′, X″, X′″ and X″″ are the same or different, and individually a fluorine, a fluorinated alkyl group, or a fluorinated phenyl group;
Ar is an aromatic group moiety having a general structure: —C₆H₄₋ₙFₙ-(n=0 to 4); C₆H₄₋ₙFₙ—CF₂—C₆H₄₋ₙFₙ-(n=0 to 8); —C₁₀H₆₋ₙFₙ-(n=0 to 6);—C₁₂H₈₋ₙFₙ-(n=0 to 8)-C₁₂H₈₋ₙFₙ;—C₁₄H₈₋ₙFₙ;—C₁₆H₈₋ₙFₙ; —C₁₆H₁₀₋ₙFₙ—; or —O—; and
n° is an integer of at least 2 but no more than a total number of sp²C—H substitution on the fluorinated-aromatic-group-moiety.

9. The precursor of claim 8, wherein the benzoxyclobutane moiety has a general structure comprising: 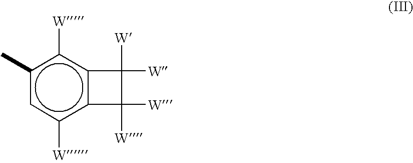
wherein, W′, W″, W′″, W″″, W′″″ and W″″″ are the same or individually a hydrogen, a fluorine or a fluorinated phenyl.

10. The dielectric thin film of claim 8, wherein a ratio of (sp²C—F+sp³C—F)/((sp²C—F+sp³C—F+sp²C—H+sp³C—H) substitutions should be at least 0.4,preferably 0.7

11. The dielectric thin film of claim 8, wherein the dielectric thin film has a dielectric constant (“ε”) value equal to or less than 2.6.

12. The dielectric thin film of claim 8, wherein one or more layers of the thin film is deposited on an integrated circuit or electronic device.

13. The dielectric thin film of claim 12, wherein the electronic device comprises: an active matrix liquid crystal display, or a fiber optic device.

14. The dielectric thin film of claim 12, wherein the integrated circuit is manufactured via a dual damascene process comprising the dielectric thin film.

15. A method of making a dielectric thin film material, comprising:
(a) dissolving or suspending a precursor of claim 1 or claim 8 in a solvent to give a solution or suspension of the precursor in the solvent;
(b) spinning the solution or the suspension of the precursor in the solvent onto a substrate to form a thin wet film;
(c) heating the thin wet film to a temperature that is below a boiling-temperature of the solvent to remove most of the solvent from the thin wet film to form a thin dried film; and
(d) heating the thin dried film to a temperature that is below a glass-transition temperature of the thin dried film to give the dielectric thin film material

16. The method of claim 15 wherein, a rate of heating the wet film occurs at 3 to 5° C. per minute to a maximum temperature that is below the boiling-temperature of the solvent.

17. The method of claim 15 wherein, the wet thin film is heated to a maximum temperature that ranges from 5 to 50° C. below the boiling-temperature of the solvent.

18. The method of claim 17 wherein, a rate of heating the thin dried film occurs at 10° C. per minute to a maximum temperature that is below the glass-transition temperature of the thin dried film.

19. The method of claim 17 wherein, the thin dried film is heated to a maximum temperature that ranges from 10 to 20° C. below the glass-transition temperature of the thin dried film.
